(19) United States
(12) Patent Application Publication
(10) Pub. No.: US 2024/0372468 A1
(43) Pub. Date: Nov. 7, 2024

(54) SEAMLESS MODE-SWITCH IN DC/DC CONVERTERS

(71) Applicant: Infineon Technologies AG, Neubiberg (DE)

(72) Inventor: Stefano Zampieri, Padova (PD) (IT)

(21) Appl. No.: 18/615,768

(22) Filed: Mar. 25, 2024

(30) Foreign Application Priority Data
May 3, 2023 (DE) 102023111370.4

(51) Int. Cl. H02M 3/157; H02M 1/00; H02M 3/158

(52) U.S. Cl. CPC H02M 3/157; H02M 1/0009; H02M 1/0025; H02M 3/158

(57) ABSTRACT

A circuit for a switching converter is described herein. In accordance with one embodiment, the circuit includes a converter stage configured to convert an input voltage into an output voltage in accordance with a modulated drive signal, an error amplifier configured to generate an error signal representing a difference between the output voltage and a reference voltage, a first and a second modulator, and a logic circuit. The first modulator is configured to generate a first control signal based on the error signal and a reference signal, wherein the reference signal is controlled dependent on the input voltage and the output voltage. The second modulator is configured to generate a second control signal based on the error signal. The logic circuit is configured to provide the drive signal based on the first control signal or the second control signal.

### TECHNICAL FIELD

The present disclosure relates to the field of switching converters such as DC/DC buck converters or the like.

### BACKGROUND

Switching converters usually can be operated in different operating modes dependent on one or more parameters such as the input voltage, the output voltage and the output current (i.e. the load). The different operating modes differ in the switching scheme that determines the switching operation of the electronic switches that control the current flow through an inductor (choke) of the switching converter.

The switching operation of electronic switches is determined by a logic signal (switching signal) that triggers activation/deactivation of the electronic switches. The logic signal, which can assume only a logic High level or a logic Low level, can be modulated using different modulation schemes in order to regulate, e.g., the output voltage or the output current. Common modulation schemes are pulse width modulation (PWM) and pulse frequency modulation (PFM). When using PWM, the duty cycle of the switching signal is adjusted by adjusting the on-time (i.e. the pulse width) of the switching signal in each switching cycle, while the switching frequency is constant. When using PFM, the switching frequency is adjusted by adjusting the temporal distance of the pulses (i.e. the frequency) of the switching signal, while the pulse-width (i.e. the on-time in a switching cycle) is constant.

Both modulations schemes may be combined in a switching converter. Accordingly, the switching controller, which generates the switching signal(s) can be operated in different modes, e.g. PWM mode, PFM mode. In some applications different PFM or PWM modes may be implemented such as PWM Continuous Conduction Mode (PWM-CCM) and PWM Discontinuous Conduction Mode (PWM-DCM).

For a specific operating point (e.g., for a specific combination of input voltage, output voltage, output current), the achievable efficiency of the power conversion can be different for different operating modes. Further, some operation modes may not be suitable for a specific range of operating points. In order to optimize efficiency, multimode switching converters have been developed, which are configured to operate in two or more different operating modes. The operating point of the switching converter is monitored (e.g. by a controller) and, if a mode switch condition is reached, the operating mode is changed.

In some operating modes stability problems may occur. Furthermore, sudden mode switch may result in undesired overshoots and undershoots of the output voltage of the switching converter. The inventor set himself the objective to improve the control of multimode switching converters so that a smooth mode transition is achieved and the mentioned overshoots or undershoots are reduced.

### SUMMARY

The objective mentioned above is achieved by the circuit of claim 1 and the method of claim 10. Various embodiments and further developments are covered by the dependent claims.

Accordingly. one embodiment relates to a circuit that includes a converter stage configured to convert an input voltage into an output voltage in accordance with a modulated drive signal, an error amplifier configured to generate an error signal representing a difference between the output voltage and a reference voltage, a first and a second modulator, and a logic circuit. The first modulator is configured to generate a first control signal based on the error signal and a reference signal, wherein the reference signal is controlled dependent on the input voltage and the output voltage. The second modulator is configured to generate a second control signal based on the error signal. The logic circuit is configured to provide the drive signal based on the first control signal or the second control signal.

Another embodiment relates to a method for a switching converter. The method includes converting—by a converter stage—an input voltage into an output voltage in accordance with a modulated drive signal, wherein an error signal is generated, which represents a difference between the output voltage and a reference voltage. A first modulator generates a first control signal based on the error signal and a reference signal and a second modulator generates a second control signal based on the error signal, wherein the modulated drive signal is provided to the converter stage based on either the first control signal or the second control signal. The method further includes controlling the reference signal for the first modulator dependent on the input voltage and the output voltage.

### BRIEF DESCRIPTION OF THE DRAWINGS

The invention can be better understood with reference to the following drawings and descriptions. The components in the figures are not necessarily to scale; instead emphasis is placed upon illustrating the principles of the invention. In the figures, like reference numerals designate corresponding parts. In the drawings:

FIG. 1 is a circuit diagram illustrating one general example of a buck-converter regulating both output voltage and inductor current (current-mode control).

FIG. 2 is a circuit diagram illustrating one example of a switching controller for PWM operation.

FIG. 3 is a circuit diagram illustrating one example of a switching controller for PFM operation.

FIG. 4 is a circuit diagram illustrating one embodiment of a switching controller for PFM operation with current feedback.

FIG. 5 is a diagram showing characteristic curves of the PFM and PWM mode operation of a multi-mode switching converter; the characteristic curves showing error voltage over duty cycle.

FIG. 6 is a diagram illustrating how the characteristic curve associated with PFM operation can be shifted so that it approximately intersects the other characteristic curve at the current operating point.

FIG. 7 illustrates a circuit that generates the reference signal for the PFM modulator based on the output voltage and the input voltage.

FIG. 8 illustrates an alternative to the circuit of FIG. 7.

### DETAILED DESCRIPTION

FIG. 1 is a circuit diagram illustrating one general example of a buck-converter. It is understood, however, that the concepts described herein may be readily applied to other switching converter topologies such as flyback-converter, buck-boost converter, boost converter, Ćuk-converter topologies, etc.

In the present example, the buck converter includes a switching circuit, which is connected between an input circuit node N_{IN} and a reference node GND (e.g. ground node). An input voltage V_{IN} is applied between the input circuit node N_{IN} and the reference node GND, which is usually at a reference potential V_{GND} (e.g. ground potential). In the present example, the switching circuit is implemented as a transistor half bridge that is composed of a high-side transistor T_{HS} and a low-side transistor T_{LS}. The two transistors T_{LS} and T_{HS} are connected in series at an output circuit node N_{B} of the switching circuit. In the present examples, the two transistors T_{LS} and T_{HS} are implemented as MOS transistors (MOSFETs). However, any other type of transistor may be employed instead. In some examples, a diode may be used instead of the low-side transistor T_{LS}.

The switching converter further includes an inductor L_{O}, which is connected between the output circuit node N_{B} of the switch circuit (e.g. the transistor half-bridge) and an output circuit node N_{O} (shortly referred to as output) of the switching converter, at which the output voltage V_{OUT} is provided. According to the present example, an output capacitor C_{O} is connected between the output N_{O} of the switching converter and the reference node GND in order to buffer the output voltage V_{O}. Generally, the switching circuit is configured to alternatingly apply the input voltage V_{IN} and the reference voltage V_{GND} to the LC-circuit composed of inductor L_{O} and capacitor C_{O}.

The switching operation of the switching circuit may be determined by one or more switching signals, which are generated by the switching controller 10. In the present example of FIG. 1 the switching signal, which is supplied to the high-side transistor T_{HS}, is denoted as S_{ON}, whereas the switching signal, which is supplied to the low-side transistor, is denoted as S̅_{ON}. It is noted that the signal S̅_{ON} is basically an inverse version of the signal S_{ON} (except for a small dead time as the case may be). In other implementations, a single switching signal S_{ON} may be sufficient, for example, because the switching circuit includes only one active electronic switch or, alternatively, circuitry for distributing the switching signal S_{ON} to two or more electronic switches. It is noted that, in some specific operating modes, both transistors of the half-bridge may be temporarily switched-off at the same time to avoid a discharge of the output capacitor C_{O}.

Pulse-width modulation (PWM) is as such known in the field of switching converters and thus the generation of the switching signal is only shortly summarized here. Generally, the switching signal S_{ON} has a constant frequency denoted as f_{SW}, while the on-time T_{ON} of the switching signal S_{ON}=S_{PWM} is adjusted in each switching cycle. The ratio T_{ON}/T_{SW} between the on-time T_{ON} and the switching period T_{SW}=f_{SW}⁻¹ is usually referred to as duty cycle D. In other words, the duty cycle of the switching signal is updated in each switching cycle in order to regulate the output voltage, while the switching period T_{SW} is substantially constant. The switching frequency f_{SW} may be determined by a clock signal S_{CLK} that may be generated by an oscillator OSC. The oscillator OSC may be implemented using any known oscillator circuit such as a relaxation oscillator circuit or the like. In a buck converter operating in PWM-CCM mode and in an idealized case without losses, etc. the duty cycle D equals V_{O}/V_{IN}.

Another modulation technique commonly used in switching converters is pulse-frequency modulation (PFM). When PFM is used, the on-time T_{ON} of the switching signal S_{ON} is substantially constant and the switching frequency f_{SW} is adjusted by the switching controller such that the output voltage V_{O} is maintained at or close to a desired set-point value.

To regulate the output voltage V_{O}, the switching controller needs some information about the output voltage. Thus, the switching converter may include a voltage sense circuit VS that is configured to directly or indirectly sense the output voltage V_{O} and provide a respective voltage sense signal V_{VS} indicative of the actual output voltage V_{O} (voltage feedback). According to one specific example, the voltage sense circuit may be implemented as a simple voltage divider. However, more complex voltage sense circuits may be used in other examples.

In some implementations, the switching controller 10 may utilize a so-called current-mode control, for which an additional current feedback is used. Accordingly, the switching controller may include a current sense circuit CS, which is configured to directly or indirectly sense the inductor current i_{L} and provide a respective current sense signal V_{CS} indicative of the actual inductor current i_{L}. In one simple example, the current sense circuit may include a current sense resistor. In other examples, more complex current sense circuits such as so-called Sense-FET arrangements may be used to sense the current. In other implementations, the switching controller 10 may utilize a so-called voltage-mode control, which does not require a current feedback.

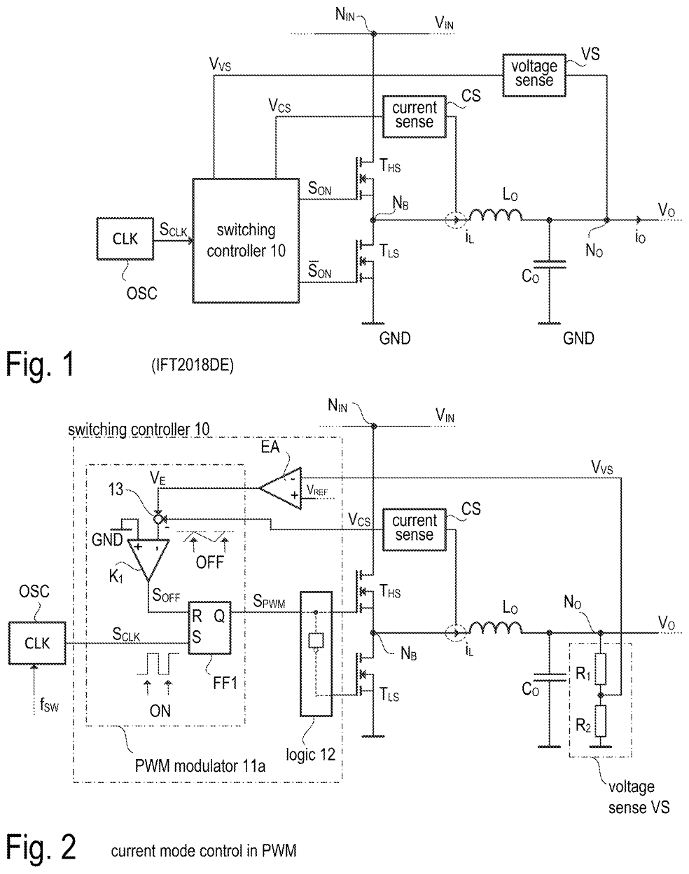

FIG. 2 illustrates one exemplary implementation of the switching controller 10, wherein only those components are shown, which are used for current-mode control during PWM operation and which relevant to the following explanations. As shown in FIG. 2, current-mode control makes use of two feedback loops, i.e. current feedback as well as a voltage feedback. Basically, a first (inner) control loop regulates the inductor current i_{L}. The (peak) current set-point (see FIG. 2, error signal V_{E}) for the current control is determined by a second (outer) control loop and set such that the output voltage V_{O} is stabilized at a desired voltage set-point.

In the example of FIG. 2, the switching controller 10 includes an RS flip-flop FF1, which receives the clock signal S_{CLK} at the set input S. Accordingly, the switching signal S_{PWM} provided at output Q of the RS flip-flop FF1 is set to a High level regularly and in synchronization with the clock signal S_{CLK}. The RS flip-flop FF1 receives a reset signal S_{OFF} at the reset input R, wherein the reset signal S_{OFF} indicates (by applying a high level at the reset input R) the time instant, at which the inductor current i_{L} reaches the current set-point. The inductor current i_{L} is represented by current sense signal V_{CS} and the current set-point by level of the error signal V_{E}.

K₁V_{CS}V_{E}K₁V_{E}V_{CS}V_{CS}V_{E}V_{E}V_{CS}K₁S_{PWM}V_{E}V_{CS} The switching controller 10 includes a comparator that is configured to compare the current sense signal with the error signal. In the present example, this comparison is implemented such that the comparator actually compares the difference

K₁V_{CS}V_{E}K₁V_{E}V_{CS}V_{CS}V_{E}V_{E}V_{CS}K₁S_{PWM}V_{E}V_{CS}—with the reference potential (e.g. 0 volts). Each time the current sense signal reaches the current level of the error signal (and thus the e difference—becomes zero), the comparator signals to the RS flip-flop FF1 to reset the switching signal to a Low level. In the present example, the difference—is obtained from the subtraction block 13.

The RS flip-flop FF1 in combination with the comparator K₁ may be regarded as a PWM modulator 11a that basically controls the duty cycle of the switching signal S_{PWM}. Accordingly, the RS flip-flop is set in each switching cycle while the reset (and thus the duty cycle) is triggered by the comparator K₁. It is understood that FIG. 2 is merely an illustrative example and many ways of implementing the function of the generic circuit of FIG. 2 are as such known.

The mentioned error signal V_{E} (i.e. the current set-point for the inner control loop) is provided at an output of error amplifier EA, which is configured to amplify the control error V_{VS}-V_{REF}, wherein V_{VS} is a voltage sense signal representing the output voltage V_{O} and V_{REF} is a reference voltage representing the voltage set-point for the outer control loop. Optionally, an integrator and/or a loop filter may be coupled between the error amplifier EA and the comparator K₁. The logic circuit 12 is configured to distribute the switching signal S_{PWM} to the electronic switches. In the present example, the logic circuit 12 may feed the switching signal S_{PWM} through to the control electrode of the transistor T_{HS} and provide the inverted signal S̅_̅{̅P̅W̅M̅}̅ to the control electrode of the transistor T_{LS}. However, other embodiments may use more complex logic circuits.

To summarize the above, in PWM-CCM the switching controller 10 makes use of two feedback loops, wherein the first feedback loop is formed by the current sense circuit CS and comparator K₁ and the second feedback loop is formed by the voltage sense circuit VS and the error amplifier EA. The first feedback loop is part of a control loop used for controlling the inductor current i_{L}, whereas the second feedback loop is part of a control loop used for controlling the output voltage V_{O}. Other implementations do not require the current feedback and only have one voltage feedback loop.

As mentioned above, PWM-CCM may not be suitable in some situations. For example, when the switching converter is loaded with only a very light load (output current low) or when the ratio V_{IN}/V_{O} is high, a mode switch to PFM-DCM or PFM-CCM (or other modes such as Burst Mode) may be necessary in order to be able to maintain the output voltage regulation. As multi-mode switching controllers are as such known, mode switch conditions are not discussed in detail herein.

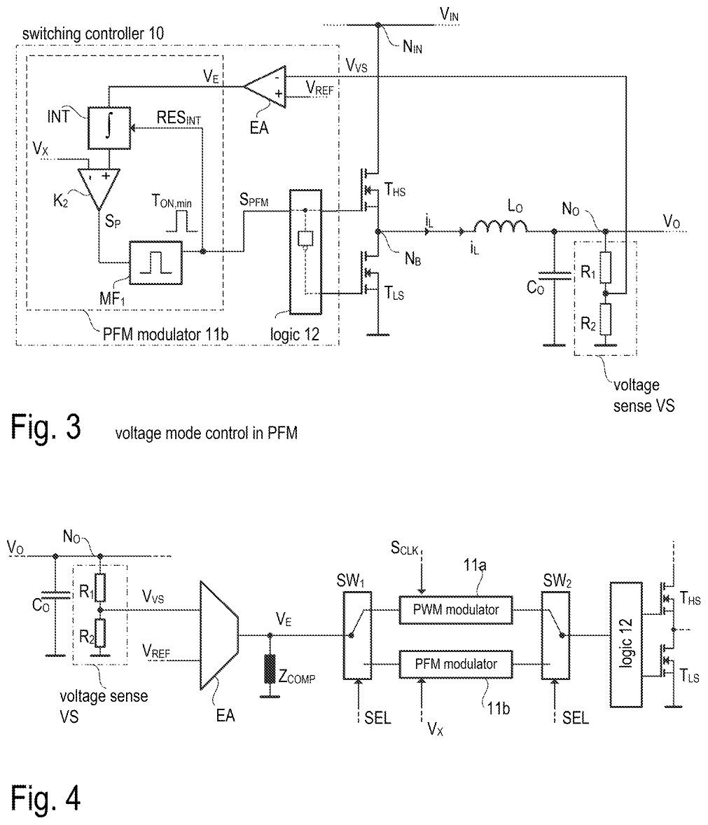

One example of a switching controller operating in a PFM-mode (e.g. PFM DCM mode or PFM-CCM mode) is illustrated in FIG. 3, wherein, to keep the illustration simple, only those components are shown which are relevant to the following explanations. Accordingly, only those portions of the switching controller 10 are shown which are used for PFM control. It is understood that both, the circuit components used for PWM operation and the circuit components used for PFM operation, as well as further circuitry for triggering mode switches or the like, can be included in the switching controller 10.

According to the FIG. 3 the converter stage (transistor half-bridge, the inductor L_{O}, and the output capacitor C_{O}), the voltage sense circuit VS, and the error amplifier EA are the same as in the example of FIG. 2. However, the configuration of the switching controller is different from the previous example. Accordingly, the output signal V_{E} of the error amplifier EA (error signal) is supplied to the (inverting) integrator INT, and the integrated error signal is compared to a threshold V_{X} (reference voltage) by comparator K₂. The output of the comparator K₂ is coupled to a mono-flop MF1 that is configured to generate a pulse of defined (and constant) pulse length T_{ON,min}.

A pulse is generated in response to the comparator K₂ detecting that the integrated error signal has reached the threshold V_{X} provided to the comparator K₂. As such, the pulse length (on-time T_{ON,min}) of the pulses in the switching signal is fixed, wherein the switching frequency f_{SW} (pulse repetition frequency) varies in accordance with the measured error signal V_{E}. As in the previous example of FIG. 2, the switching signal S_{PFM} is supplied to the logic circuit 12, which provides respective drive signals to the high side transistor T_{HS} and the low-side transistor T_{LS} of the half-bridge. It is noted that the integrator INT and the comparator K₂ in combination with the mono-flop MF₁, which provides the reset signal RES_{INT} for the integrator INT, can be seen as a kind of a voltage controlled oscillator or PFC modulator circuit 11b in FIG. 3. The higher the input voltage V_{E}, the steeper is the slope of the integrator output voltage V_{I} and thus the higher the pulse repetition frequency (switching frequency f_{SW}) of the pulses at the output of the monoflop MF1 (signal S_{PFM}). In each switching cycle, the integration time restarts at the end of the on-time T_{ON,min}.

As can be seen in FIG. 3, only one feedback loop is used during conventional PFM operation; the current sense circuit CS may or may not be in use in PFM operating modes. The control structure shown in FIG. 3 basically generates one pulse of the switching signal S_{PFM} each time the integrated error signal V_{E} reaches a specific threshold value V_{X}. It is noted that various alternative implementations of the PFM modulator 11b may be used to provide basically the same function.

FIG. 4 illustrates one example of how a PWM modulator and a PFM modulator may be combined to implement a multi-mode switching converter. Again, only those components are shown in the drawing, which are relevant for the further discussion. In particular, the circuitry that is responsible for monitoring mode switch conditions and triggering a mode switch has been omitted.

FIG. 4 includes, on the left side, the output capacitor C_{O} of the switching converter and the voltage sense circuit VS, which is a simple voltage divider (composed of resistors R₁ and R₂) in the present example. The error amplifier EA receives the voltage sense signal V_{VS} and the reference voltage V_{REF}, which represents the target (set-point) value for the output voltage. A impedance Z_{COMP} is coupled to the output of the error amplifier EA dependent on the actual implementation. The error signal V_{E} provided by the error amplifier EA is directed to either the PWM modulator 11a or the PFM modulator 11b via switch SW₁. Dependent on the operating mode, electronic switch SW₁ connects the output of the error amplifier EA either to the input of the PWM modulator 11a or the PFM modulator 11b in accordance with a selection signal SEL, which may be provided, for example, by a mode switch circuit or any other suitable control circuit, which may be included, e.g. in an external controller device. Similarly, the output of either the PWM modulator 11a or the PFM modulator 11b is connected to the input of the logic circuit 12 via a further electronic switch SW₂ which may also be controlled by selection signal SEL. As mentioned, the logic circuit provides the drive signals for the transistors T_{LS} and T_{HS} based on the switching signal S_{PWM} or S_{PFM} dependent on the mode. It is noted that the electronic switch SW₂ may be omitted dependent on the actual implementation of the overall circuit. Its function may also be provided by the logic circuit 12. The function of the further electronic switch SW₂ may also be included in the logic circuit 12 dependent on the actual implementation. The selection signal SEL may be regarded as a mode selection or mode switch signal.

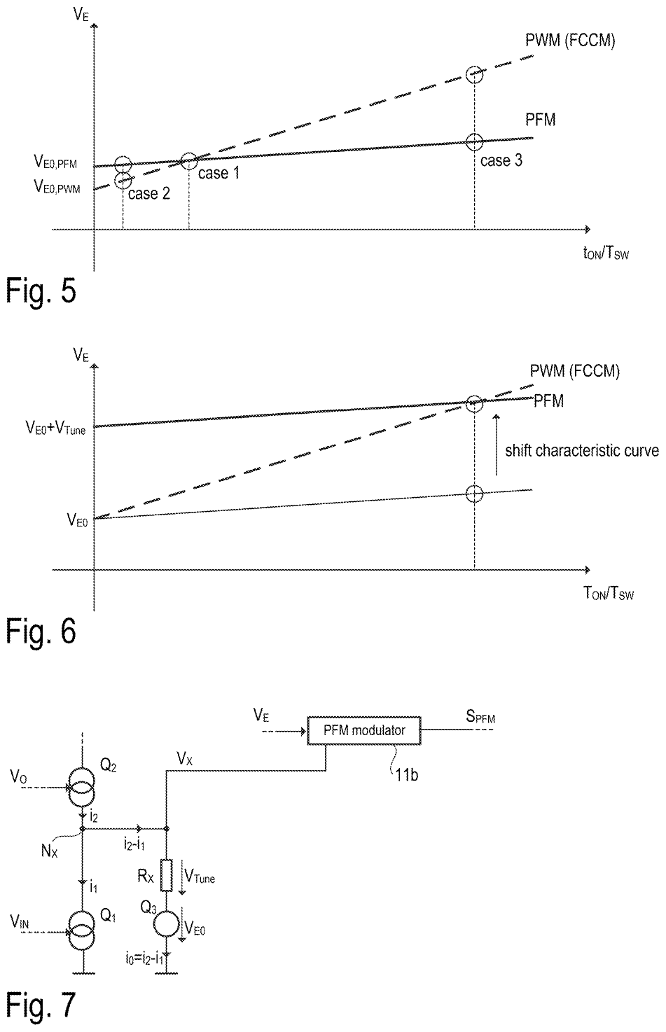

The diagram of FIG. 5 visualizes a problem that may result from a sudden mode switch from e.g. PWM-CCM mode to PFM mode or vice versa. The diagram shows characteristic curves for PWM and PFM operation that indicate how—in steady state—the output voltage V_{E} of the error amplifier depends on the ratio T_{ON}/T_{SW} (on-time over cycle time) which equals the duty cycle. The two characteristic curves are straight lines (characterized by offset and steepness), wherein the dashed line is the characteristic curve for PWM-CCM mode and the solid line for PFM mode.

For the further discussion, it is assumed that the switching converter operates in PWM mode and has a specific duty cycle in steady state indicated as “case 3” in FIG. 5. In PFM mode, for the same ratio T_{ON}/T_{SW}, the steady state error voltage V_{E} would be lower than in PWM mode. As a consequence, immediately after a mode switch to PFM mode, the error voltage V_{E} would be too high for the current operating point (output voltage), and, as a consequence, the transient response of the switching controller will cause a significant overshoot at the output of the switching converter. Conversely, an undershoot will be generated after a mode switch from PFM to PWM mode. The reverse effect can be observed when the switching converter operates in PWM mode and has a specific duty cycle in steady state indicated as “case 2” in FIG. 5. Then a switchover to PFM would cause an undershoot. Only for one specific ratio T_{ON}/T_{SW} indicated as “case 1”, the error voltages are equal because the two characteristic curves intersect. In this situation, a mode switch would not cause any overshoots or undershoots in the output voltage V_{O}.

The embodiments described herein are designed to avoid or at least reduce the mentioned over- and undershoots in response to a mode switch. Accordingly, the embodiments described herein are configured to shift the characteristic curve for the PFM mode so that the two characteristic curves intersect at the ratio T_{ON}/T_{SW}. Accordingly, the ratio T_{ON}/T_{SW} (duty cycle) in the steady state does not significantly change upon a mode switch (e.g. from PWM to PFM or vice versa), and thus transients like undershoots and overshoots are avoided. A shift of the characteristic curve may be achieved by tuning the reference voltage V_{X}, which is used by the PFM modulator (see FIG. 3). Another—theoretic—option would be to tilt the characteristic curve for PFM mode. However, this is, in general, not possible due to other constraints given by the circuit design.

V_{E}V_{IN}V_{O}V_{O}/V_{IN}V_{E}=(α·V_{O}−β·V_{IN})+V_{E0,PWM}αβV_{E0,PWM}V_{E0,PWM}=V_{E}(0)V_{E0,PWM}V_{E0,PFM}V_{E0,PWM}V_{E0,PFM}V_{E0}S_{PFM}S_{PWM} It can be shown, that in PWM mode, the output voltage of the error amplifier EA is a function of the input voltage and the output voltage. In particular, it is a function of the ratio. This function may be linearized to have the following form

V_{E}V_{IN}V_{O}V_{O}/V_{IN}V_{E}=(α·V_{O}−β·V_{IN})+V_{E0,PWM}αβV_{E0,PWM}V_{E0,PWM}=V_{E}(0)V_{E0,PWM}V_{E0,PFM}V_{E0,PWM}V_{E0,PFM}V_{E0}S_{PFM}S_{PWM}

V_{E}V_{IN}V_{O}V_{O}/V_{IN}V_{E}=(α·V_{O}−β·V_{IN})+V_{E0,PWM}αβV_{E0,PWM}V_{E0,PWM}=V_{E}(0)V_{E0,PWM}V_{E0,PFM}V_{E0,PWM}V_{E0,PFM}V_{E0}S_{PFM}S_{PWM}

V_{E}V_{IN}V_{O}V_{O}/V_{IN}V_{E}=(α·V_{O}−β·V_{IN})+V_{E0,PWM}αβV_{E0,PWM}V_{E0,PWM}=V_{E}(0)V_{E0,PWM}V_{E0,PFM}V_{E0,PWM}V_{E0,PFM}V_{E0}S_{PFM}S_{PWM}

V_{E}V_{IN}V_{O}V_{O}/V_{IN}V_{E}=(α·V_{O}−β·V_{IN})+V_{E0,PWM}αβV_{E0,PWM}V_{E0,PWM}=V_{E}(0)V_{E0,PWM}V_{E0,PFM}V_{E0,PWM}V_{E0,PFM}V_{E0}S_{PFM}S_{PWM} wherein and are constant parameters, which depend on the circuit design, and is the offset of the characteristic curve (i.e. in PWM mode, see FIG. 5). Further, the circuit may be designed such that the offsets and are equal (==). The additional shift of the characteristic curve is illustrated in FIG. 6. The difference (in volts), by which the curve is shifted is denoted as V_{Tune}. This shift results in a situation which corresponds to “case 1” shown in FIG. 5. Accordingly, the steady-state duty cycle value is approximately the same for PWM mode and PFM mode. In other words, the reference signal V_{X} for the PFM modulator 11b is controlled such that the resulting duty cycle of the modulated signal provided by the PFM modulator 11b approximately matches the duty cycle of the modulated signal provided by the PWM modulator 11a. As a consequence, transients are avoided or at least reduced in amplitude when switching over from one mode to another mode (e.g. from PWM to PFM and vice versa).

One exemplary approach how the shift of the characteristic curve can be implemented is illustrated in FIG. 7. To keep the illustration simple, FIG. 7 only includes the PFM modulator 11b and the circuitry which is used to generate the reference voltage V_{X} for the PFM modulator 11b. The concept illustrated in FIG. 7 may be applied to the multi-mode switching converter of FIG. 4.

To generate the reference voltage V_{X} a first controllable current source Q₁ and a second controllable current source Q₂ are connected to a circuit node N_{X}. The current source Q₁ is configured to sink a current i₁ from the circuit node N_{X}, whereas current source Q₂ supplies a current i₂ to the circuit node N_{X}. The current i₁ depends on the input voltage V_{IN} and the current i₂ depends on the output voltage V_{O}. The transconductances of the current sources depend on the parameters α and β mentioned above. The difference current i₂−i₁ is drained via a resistor R_{X} and offset voltage source Q₃ that provides the offset voltage V_{E0}. The resistor R_{X} and the voltage source Q₃ are connected in series between the node N_{X} and reference potential (ground). The voltage drop V_{Tune} across the resistor R_{X} equals R_{X}i₂−R_{X}i₁=αV_{O}−βV_{IN}. As a result, the total reference voltage V_{X} that is supplied to the PFM modulator 11b is V_{Tune}+V_{E0}. In essence, the reference signal V_{X} is a weighted sum of input and output voltages plus an offset. For example, the offset V_{E0} may be set such that the characteristic curves approximately intersect at T_{ON}/T_{SW}=0 (cf. FIG. 6)

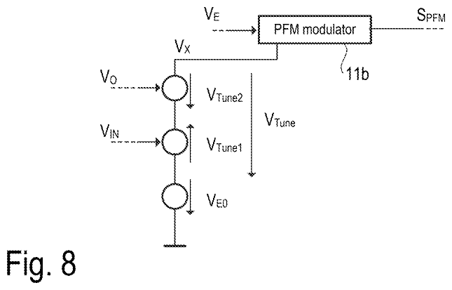

It is understood that the circuit of FIG. 7 is merely an example. A similar function can be implemented in various different ways. Another example is shown in FIG. 8. Accordingly, the voltage sources are connected in series to provide the voltage V_{X} as the sum of the voltages V_{E0}, V_{Tune1}, and V_{Tune2}. A first controllable voltage source provides the voltage V_{Tune1} as a function of the input voltage V_{IN} (V_{Tune1}=βV_{IN}), a second controllable voltage source provides the voltage V_{Tune2} as a function of the output voltage V_{O}(V_{Tune2}=αV_{IN}), whereas a third voltage source provides the constant offset voltage V_{E0} lile in the previous example. The three voltages sum up to V_{Tune2}−V_{Tune1}+V_{E0} (see FIG. 8). V_{Tune1} has a negative sign because the first voltage source has a reversed polarity.

Various embodiments described herein are summarized below. It is understood that the following is not an exhaustive list but rather an exemplary summary. A first embodiment relates to a circuit for a multi-mode switching converter. The circuit includes a converter stage configured to convert an input voltage into an output voltage in accordance with a modulated drive signal and an error amplifier configured to generate an error signal representing a difference between the output voltage and a reference voltage. The circuit further includes a first modulator (e.g. the PFM modulator 11b) configured to generate a first control signal based on the error signal and a reference signal (see FIG. 4, reference signal V_{X}), wherein the reference signal is controlled dependent on the input voltage and the output voltage (see FIGS. 7 and 8), and a second modulator (e.g. the PWM modulator 11a) configured to generate a second control signal based on the error signal. Furthermore, the circuit includes a logic circuit configured to provide the drive signal based either on the first control signal or the second control signal.

In one embodiment the error amplifier is configured to receive a first signal (see FIG. 4, voltage sense signal V_{VS}) representing the output voltage and a second signal representing a reference voltage (see FIG. 4, reference voltage V_{REF}), wherein the error signal represents the difference between the first signal and the second signal. The first modulator may be a pulse-frequency modulator and, thus, the first control signal has a pulse-frequency that depends on the error signal and the reference signal. The second modulator may be a pulse-width modulator and, thus, the second control signal has a specific frequency and a duty cycle that depends on the error signal.

In one embodiment the logic circuit is configured to output either the first control signal or the second control signal as modulated drive signal for the switching stage. In one embodiment, a switching circuit may be coupled to an output of the error amplifier and configured to direct the error signal—dependent on a selection signal—either to the first modulator or to the second modulator (see FIG. 4, first switch SW₁). A further switching circuit may be coupled to the outputs of the first and the second modulators and configured to direct—dependent on the selection signal—either the first control signal or the second control signal as modulated drive signal to the switching stage. The function of the further switching circuit may also be implemented by the logic circuit.

A further embodiment relates to a method for a switching converter. Accordingly, the method includes converting—by a converter stage—an input voltage into an output voltage in accordance with a modulated drive signal. For this purpose, an error signal is generated, which represents a difference between the output voltage and a reference voltage, wherein a first modulator generates a first control signal based on the error signal and a reference signal (see FIG. 4, reference signal V_{X}) and a second modulator generates a second control signal based on the error signal. The modulated drive signal is provided to the converter stage based on the first control signal or the second control signal. The method further includes controlling the reference signal for the first modulator dependent on the input voltage and the output voltage.

Although the invention has been illustrated and described with respect to one or more implementations, alterations and/or modifications may be made to the illustrated examples without departing from the spirit and scope of the appended claims. In particular regard to the various functions performed by the above described components or structures (units, assemblies, devices, circuits, systems, etc.), the terms (including a reference to a “means”) used to describe such components are intended to correspond—unless otherwise indicated—to any component or structure, which performs the specified function of the described component (e.g., that is functionally equivalent), even though not structurally equivalent to the disclosed structure, which performs the function in the herein illustrated exemplary implementations of the invention.

1. A circuit comprising:
a converter stage configured to convert an input voltage into an output voltage in accordance with a modulated drive signal;
an error amplifier configured to generate an error signal representing a difference between the output voltage and a reference voltage;
a first modulator configured to generate a first control signal based on the error signal and a reference signal, wherein the reference signal is controlled dependent on the input voltage and the output voltage;
a second modulator configured to generate a second control signal based on the error signal; and
a logic circuit configured to provide the drive signal based on the first control signal or the second control signal.

2. The circuit of claim 1,
wherein the error amplifier is configured to receive a first signal representing the output voltage and a second signal representing the reference voltage, and
wherein the error signal represents the difference between the first signal and the second signal.

3. The circuit of claim 1,
wherein the first modulator comprises a pulse-frequency modulator and the first control signal has a pulse frequency that depends on the error signal and the reference signal.

4. The circuit of claim 3,
wherein the second modulator comprises a pulse-width modulator and the second control signal has a specific frequency and a duty cycle that depends on the error signal.

5. The circuit of claim 1,
wherein the logic circuit is configured to output the first control signal or the second control signal as the modulated drive signal for the switching stage.

6. The circuit of claim 1, further including:
a switching circuit that is coupled to an output of the error amplifier and configured to direct the error signal, dependent on a selection signal, either to the first modulator or to the second modulator.

7. The circuit of claim 6, further including:
a further switching circuit that is coupled to the outputs of the first and the second modulators and configured to direct, dependent on the selection signal, either the first control signal or the second control signal as the modulated drive signal to the switching stage.

8. The circuit of claim 6,
wherein the selection signal is provided by an external controller device.

9. The circuit of claim 1,
wherein the reference signal is controlled such that, for the input voltage and the output voltage, a duty cycle of the first control signal provided by the first modulator approximately matches a duty cycle of the second control signal provided by the second modulator.

10. A method comprising:
converting, by a converter stage, an input voltage into an output voltage in accordance with a modulated drive signal;
wherein an error signal is generated, which represents a difference between the output voltage and a reference voltage,
wherein a first modulator generates a first control signal based on the error signal and a reference signal and a second modulator generates a second control signal based on the error signal,
wherein the modulated drive signal is provided to the converter stage based on the first control signal or the second control signal; and
wherein the method further comprises:
controlling the reference signal for the first modulator dependent on the input voltage and the output voltage.

11. The method of claim 10, further comprising:
directing the error signal, dependent on a selection signal, either to the first modulator or the second modulator.

12. The method of claim 11,
wherein, in a first mode first, the first control signal is provided to the converter stage as the modulated drive signal and, in a second mode, the second control signal is provided to the converter stage as the modulated drive signal, and
wherein the reference signal for the first modulator is controlled such that a duty cycle of the first control signal provided by the first modulator approximately matches a duty cycle of the second control signal provided by the second modulator.
